(19) United States
(12) Patent Application Publication
(10) Pub. No.: US 2004/0259999 A1
(43) Pub. Date: Dec. 23, 2004

(54) Polyester/clay nanocomposite and preparation method

(75) Inventors: Junkyung Kim, Dongdaemun-gu (KR); Soonho Lim, Songpa-gu (KR); Min Park, Nowon-Gu (KR); Sang-Soo Lee, Goyang (KR); Geon-Woong Lee, Seocho-gu (KR); Young-Tae Ma, Dobong-Gu (KR)

Correspondence Address: DARBY & DARBY P.C., P. O. BOX 5257, NEW YORK, NY, 10150-5257, US

(73) Assignee: Korea Institute of Science and Technology, Seoul (KR)

(21) Appl. No.: 10/784,035

(22) Filed: Feb. 20, 2004

(30) Foreign Application Priority Data
Jun. 20, 2003 (KR) 40376/2003

(51) Int. Cl. C08K 3/34

(52) U.S. Cl. 524/445

(57) ABSTRACT

Disclosed are a polyester/clay nanocomposite, and a preparation method thereof, comprising mixing a cyclic ester oligomer with a layered clay having an enhanced hydrophobicity and directly polymerizing the cyclic ester oligomer. The polyester/clay nanocomposite has an excellent processibility due to its low melting viscosity and has excellent mechanical and electrical properties. Therefore, it can replace conventional polyester resin applied as electronic material, as well as can be used as a compatibilizing agent for increasing compatibility of the conventional polyester/clay composite.

### BACKGROUND OF THE INVENTION

1. Field of the Invention

The present invention relates to a polyester/clay nanocomposite and a preparation method thereof.

2. Description of the Prior Art

There have been two conventional methods for preparing a polyester/clay nanocomposite.

In the first method, monomers for preparing a polyester, for example, terephthalic acid (TPA) and ethylene glycol (EG) in the case of preparing poly(ethylene terephthalate) (PET), are diffused between silicate layers of an organically modified clay and then polymerized so as the clay to be separated and dispersed.

In the second method, an intercalant having a low molecular weight is inserted between silicate layers of a clay so as to make a polymer resin easily diffused therebetween, and then the resulting clay is compounded with a melted PET having a high molecular weight.

However, the first method is disadvantageous in that it is required to accurately adjust the ratio of the equivalents between the monomers TPA and EG in order to obtain the PET having high degree of polymerization, a high vacuum below 1.0 torr is required in order to completely remove byproducts of the polymerization, and it takes too much time to reach a high enough molecular weight. Therefore, it has been known to be difficult to carry out polymerization in the presence of a clay and to prepare a nanocomposite using the same method.

Meanwhile, the second method in which a clay is directly compounding with a PET having a high molecular weight is also disadvantageous in that the PET resin can not easily diffuse into layers of the clay due to its high melting viscosity, and therefore, it is difficult for the clay to be separated and dispersed.

There has been known from various researches that when a polymer is prepared from a cyclic oligomer, the molecular weight of the produced polymer can be controlled, the processibility during polymerization is high due to the low viscosity of the cyclic oligomer, and a polymerization product can be obtained in a short time without generation of volatile substances (Macromolecules, 2000, 33, 5053-5054). Therefore, researches for preparing polycarbonate, poly(butylene terephthalate) (PBT), etc. have been actively conducted (Referring to Macromolecules, 1998, 31, 4782-4790).

Xinyu Huang et al. have reported a preparation method of a polycarbonate/clay nanocomposite from a cyclic carbonate oligomer and a montmorilonite treated with an organic material, and properties of such nanocomposite (Macromolecules, 2000, 33, 2000-2004).

William McKnight et al. have reported that where a cyclic oligomer of PBT is polymerized in the presence of poly(vinyl butyral) (PVB), a ring of the oligomer is opened and then chemically bond with PVB chain, so as the compatibility between two components to be greatly increased compared with a conventional PVB/PBT blend (Polymer, 44(2003), 1835-1842).

### SUMMARY OF THE INVENTION

Therefore, an object of the present invention is to provide a polyester/clay nanocomposite in which even silicate layers of a clay, which are minimum constitution units of the clay, are completely separated, and to provide a preparation method thereof.

Another object of the present invention is to provide a polyester/clay nanocomposite by a recycling of plastic wastes.

Still another object of the present invention is to provide a compatibilizing agent for increasing the compatibility of a composite of a conventional saturated polyester having a high molecular weight and a clay.

The foregoing and other objects, features, aspects and advantages of the present invention will become more apparent from the following detailed description of the invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A shows results of an HPLC analysis for cyclic ethylene terephthalate oligomers (ETC, i.e., cyclic ester oligomers of PET) prepared by a synthetic method;

FIG. 1B shows results of an HPLC analysis for cyclic butylene terephthalate oligomers (BTC, i.e., cyclic ester oligomers of PBT) prepared by a synthetic method;

FIG. 2 shows results of differential scanning thermal calorimetry measurements for the PET/clay nanocomposite prepared from a cyclic ester oligomer (ETC) and an organically modified clay (Cloisite 30B™) with varying polymerization temperatures;

FIG. 3 shows results of an X-ray diffraction analysis for the PET/clay nanocomposite prepared from ETC and an organically modified clay (Cloisite 30B™) in Example 2 (2); and

FIG. 4A shows a transmission electron microphotograph of the mixture of the clay and ETC prepared in Example 1 (2).

FIG. 4B shows a transmission electron microphotograph of the of PET/clay nanocomposite prepared in Example 2 (2).

### DETAILED DESCRIPTION OF THE PREFERRED EMBODIMENTS

Reference will now be made in detail to the preferred embodiments of the present invention, examples of which are illustrated in the accompanying drawings.

The objects of the present invention can be achieved by mixing a cyclic ester oligomer having a low melting viscosity and a fast polymerization rate, which can be obtained by an extraction from plastic wastes or by a chemical synthesis, with a layered clay having an enhanced hydrophobicity, i.e., an organically modified layered clay, making the cyclic ester oligomer intercalated between silicate layers of the clay, and then polymerizing the cyclic ester oligomer, to obtain a clay-dispersed polyester nanocomposite in which even silicate layers of the clay, which are minimum constitution units of the clay, are completely disintegrated.

Therefore, the present invention relates to a composition for preparing a polyester/clay nanocomposite, to a polyester/clay nanocomposite using the same, and to a preparation method thereof.

The composition for preparing a polyester/clay nanocomposite according to the present invention comprising a layered clay and a cyclic ester oligomer, in which the cyclic ester oligomer is intercalated between layers of the clay. In the composition, the cyclic ester oligomer and the clay are mixed in the ratio of 100: 0.1-10 by weight.

The cyclic ester oligomer is preferably one or more oligomers of a polyester such as PET, PBT, poly(ethylene isophthalate), poly(2.6-dinaphtoate), poly(ethylene 2.6-naphthalenedicarboxylate) and the like, which can be obtained by a condensation polymerization of two types of monomers.

The cyclic ester oligomer used in the present invention can be obtained by a synthesis from an appropriate starting material, or by depolymerization, solvent extraction method, suspension method or solution method from plastic wastes. Therefore, the preparation method of a polyester/clay nanocomposite according to the present invention can be a method for recycling plastic wastes. The cyclic ester oligomer obtained by one of the above methods may be a mixture of oligomers of a polyester, which have different ring size. In the present invention, such mixture can be used without further purification.

The clay consists of an anionic phyllosilicate of layered aluminum or magnesium silicate and Na⁺ or K⁺ ion filled between the layers of the silicate. The phyllosilicate is preferably selected from the group consisting of montmoillonite, hectorite, saponite, beidellite, nontronite, vermiculite and halloysite.

The composition for preparing a polyester/clay nanocomposite according to the present invention is prepared by mixing a cyclic ester oligomer with an organically modified clay in an appropriate organic solvent, making the cyclic ester oligomer intercalated into layers of the organically modified clay, and then removing the organic solvent.

Examples of the organic solvent may include a halogen compound such as CHCl₃, CH₂Cl₂, etc. and a polar organic solvent such as tetrahydrofuran (THF). However, the organic solvent is not limited to the above examples and may include any solvent which can dissolve a cyclic ester oligomer and can be easily removed.

The present invention also relates to a method for preparing a polyester/clay nanocomposite by polymerizing the cyclic ester oligomer which is intercalated between layers of the organically modified clay, using the aforementioned composition for preparing a polyester/clay nanocomposite.

The polymerization of the cyclic ester oligomer is preferably carried out at 180-280° C. for 5-10 minutes. An organometallic compound in which an alkyl, benzyl or aryl group is bonded with a transition metal may be used as a polymerization catalyst. The transition metal may be titanium, tin, antimony, aluminum or zirconium. Specific examples of such polymerization catalyst may include titanium alkoxide, antimony glycoxide, aluminum butoxide and zirconium ethoxide. However, in the present invention, in addition to the aforementioned catalysts, any catalysts generally known for polyester polymerization can be used. In the case of using a polymerization catalyst, it is preferably used in an amount of 0.05-2.0 weight parts for 100 weight parts of the cyclic ester oligomer

In the polyester/clay nanocomposite of the present invention, interlayer distances between silicate layers of the clay are widened in the range of from at least 50 nm to several hundreds of nanometers, and therefore, the silicate layers of the clay are completely separated so that the clay does not have layered structure any longer. Therefore, in the polyester/clay nanocomposite of the present invention, the clay exists well dispersed within the polyester matrix.

Herein, the ‘organically modified clay’ means a clay which was organically modified by a well known method to a person of ordinary skill in the art, and it can be selected from commercialized products. Representative examples of the organically modified clay which can be used in the present invention may be Cloisite™ clays from Southern Clay Co., U.S.A.

In the present invention, cyclic ester oligomers having low melting viscosity and short polymerization time are used, and thus, it is possible to prepare a polyester/clay nanocomposite in a desired shape by using a reaction molding process accompanying with a chemical reaction, such as a reaction injection molding or a reactive extrusion.

### EXAMPLES

Hereinafter, the present invention will be described in more detail by way of examples, but the present invention is not limited thereto.

### Example 1

### Preparation of Cyclic Ester Oligomer

(1) Preparation by Depolymerization

10 g of PET and 1.1 l of o-dichlorobenzene were put into a reactor, and titanium based catalyst, for example, Ti(O-i-C₃H₇)₄, in an amount of 3 mol % of the PET was then added to the reactor. The resulting mixture was heated at 240° C. After 90 minutes, the temperature of the reaction mixture was cooled down to 100° C. and then filtered to remove unreacted linear polymer, and solvent was removed by a vacuum distillation under a reduced pressure. Residual solid was re-crystallized and then filtered to obtain cyclic ester oligomers of PET approximately in 50% yield.

In obtaining cyclic ester oligomers of PBT, the above-mentioned procedure except heating at 190° C. was applied, resulting in 60% in yield.

(2) Preparation by a Synthetic Method

Dichloromethane (1 l), triethylamine (78.3 ml 0.57 mol) and 1,4-diazabicyclo[2,2,2]octane (“DABCO”, 1.49 g, 13.3 mmol) were put into a reactor. Into the reactor, butanediol (24 g, 23.6 ml) when preparing PBT oligomers, and EG (16.6 g, 14.87 ml) when preparing PET oligomers was respectively added in portion together with 1M terephthaloyl chloride (54.14 g) for 30 min to one hour. The reaction mixture was cooled down to room temperature and aqueous ammonia solution was then added thereto to quench the reaction. Solid was filtered, washed respectively with hydrochloric acid and deionized water three times, and then filtered to give cyclic ester oligomers of PET or PBT in 60% yield.

(3) Solvent Extraction Method

In general, a commercially available PET or PBT contains cyclic ester oligomers in an amount of 3-5 wt. %. Cyclic ester oligomers can be dissolved in dichloromethane or tetrahydrofuran. Thus, cyclic ester oligomers of PET or PBT were obtained by a solvent extraction method from commercially available PET or PBT, respectively.

(4) Suspension Method

PET was put into a hydrocarbon solvent, for example, a hexadecane, in which PET polymers and linear oligomers can not be dissolved and only cyclic ester oligomers can be dissolved. A titanium based catalyst, for example, Ti(O-i-C₃H₇)₄ was added thereto. The reaction mixture was then refluxed at 200° C. and then filtered to obtain cyclic ester oligomers of PET. In the case of using bis(β-hydroxyethyl)terephthalate, “BHET”) instead of PET resin, similar result can be obtained.

(5) Solution Method

BHET was put into a solvent, for example, 1-methylnaphthalene, in which PET polymers, linear oligomers, a catalyst such as Ti(O-i-C₃H₇)₄ or Al(O-i-C₃H₇)₄, and cyclic ester oligomers can be all dissolved or can not be dissolved at all, and the resulting mixture was heated for one hour. EG and the solvent were removed by distillation, and small amount of Sb₂O₃ or Ti(O-i-C₃H₇)₄ as a catalyst was added to the residue. The reaction mixture was cooled down to room temperature and then filtered to give cyclic ester oligomers of PET.

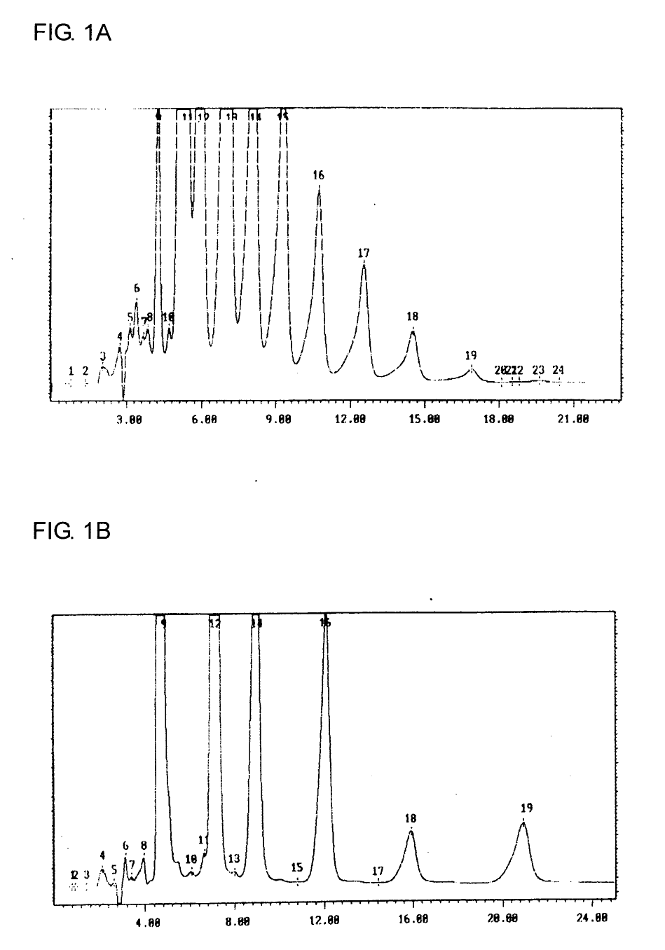

FIG. 1A shows results of an HPLC analysis for the cyclic ethylene terephthalate oligomers, i.e., ester oligomers of PET, prepared by a synthetic method in Example 1, by which the distribution of the ring size in the product can be identified.

FIG. 1B shows results of an HPLC analysis for the cyclic butylene terephthalate oligomers, i.e., ester oligomers of PBT, prepared by a synthetic method in Example 1. It can be identified from the distribution of the ring size in the product that main products are dimer and trimer.

### Example 2

### Preparation of Polyester/Clay Nanocomposite

(1) Preparation of PBT/Clay Nanocomposite

1, 3 and 5 weight parts of Cloisite 30B™ (available from Southern Clay Co., U.S.A.) were respectively added to 1 l of dichloromethane together with 100 weight parts of the cyclic ester oligomers of PBT prepared in Example 1, to make the cyclic ester oligomers inserted between layers of the clay. After removing dichloromethane, the mixture of the oligomers and clay was put into a sealed container, and remaining water and solvent were removed using a vacuum pump while heating the mixture at 100° C. for 20 min. After the oligomers were melted by heating the mixture at 180-240° C., 0.1 weight parts of Ti(O-i-C₃H₇)₄ was added to the mixture, and then the oligomers were polymerized for 5-10 min at the same temperature. The reaction mixture was then cooled with ice water to obtain the desired PBT/clay nanocomposite.

(2) Preparation of PET/Clay Nanocomposite

1, 3 and 5 weight parts of Cloisite 30B™ (available from Southern Clay Co., U.S.A.) were respectively added to 1 l of dichloromethane together with 100 weight parts of the cyclic ester oligomers of PET prepared in Example 1, to make the cyclic ester oligomers inserted between layers of the clay. After removing dichloromethane, the mixture of the oligomers and clay was put into a sealed container, and remaining water and solvent were removed using a vacuum pump while heating the mixture at 100° C. for 20 min. After the oligomers were melted by heating the mixture at 240-280° C., 0.1 weight parts of Ti(O-i-C₃H₇)₄ was added to the mixture, and then the oligomers were polymerized for 5-10 min at the same temperature. The reaction mixture was then cooled with ice water to obtain the desired PET/clay nanocomposite.

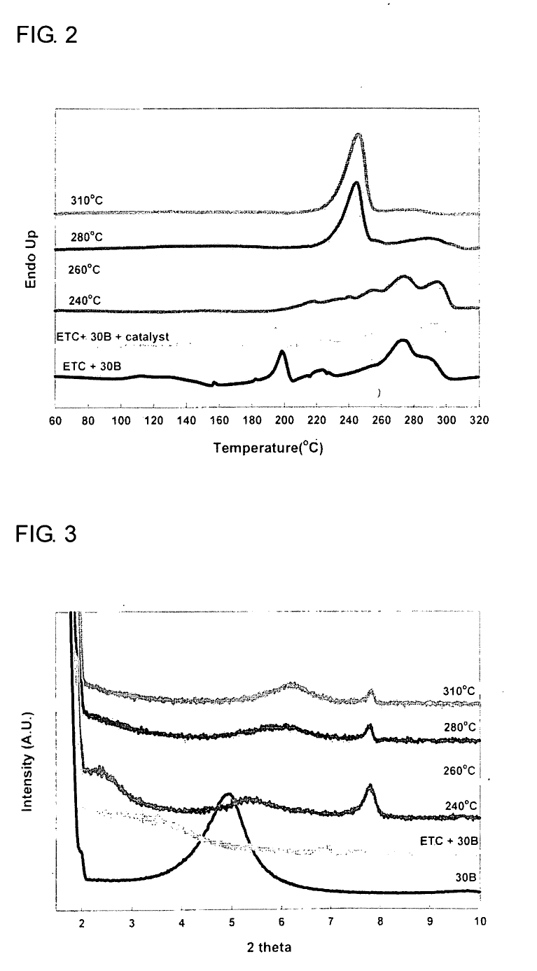

FIG. 2 shows results of differential scanning calorimetric analysis for a PET/clay nanocomposite prepared by polymerizing cyclic ester oligomers intercalated between layers of the clay (Cloisite 30B™) respectively at 240, 260, 280 and 310° C. for 5-10 min. It has been known to take more than 24 hours of polymerization for obtaining polyester of high molecular weight by a conventional condensation polymerization using diol and diacid monomers. However, it was discovered that because cyclic ester oligomers are used in the present invention, it only takes about 10 minutes for the polymerization at the temperature range of 240-280° C.

FIG. 3 shows results of an X-ray diffraction analysis for the PET/clay nanocomposite prepared in Example 2 (2). It can be seen that while increasing the polymerization temperature, the peaks at around 6° are observed but very week, and an X-ray diffraction peak at around 2.5° was completely disappeared. It means that layered structure of the clay in the polyester/clay nanocomposite according to the present invention were completely disintegrated. Additionally, similar phenomena were observed regardless of the content of the clay, but it can be seen that the separation effect is excellent when the content of the clay is below 10 weight parts, preferably within 5 weight parts for 100 weight parts of the cyclic ester oligomers.

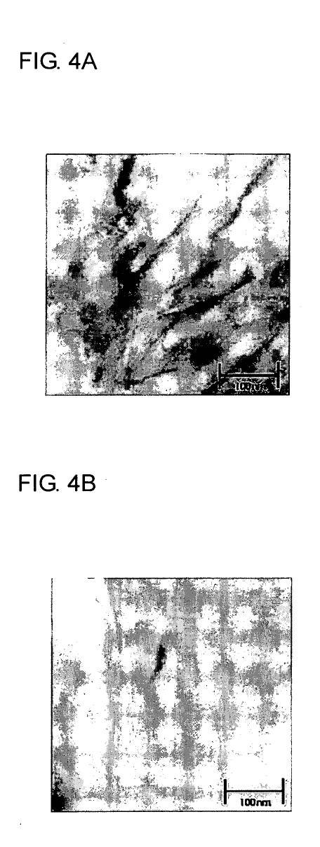

FIG. 4A shows a transmission electron microphotograph of the mixture of the clay and cyclic ester oligomer of PET prepared in Example 1 (2). It can be seen that interlayer distances of the clay became wide due to the intercalation of the cyclic ester oligomers into the layers of the clay.

FIG. 4B shows a transmission electron microphotograph of the of PET/clay nanocomposite prepared in Example 2 (2). It can be seen that the layered silicate which is the minimum constitution unit of the clay was separated 50 nm or more, and the degree of dispersion of the clay particles is excellent in the polyester matrix compared with in the conventional polyester/clay composite.

The preparation method of the polyester/clay nanocomposite according to the present invention makes it possible to obtain within 10 min a polyester/clay nanocomposite, in which clay particles are uniformly dispersed in the polyester matrix having a mean molecular weight of 2,000-200,000, having mechanical strength and thermal and electrical properties suitable to be used as an electronic material.

In addition, because the polyester/clay nanocomposite according to the present invention is prepared from the cyclic nanocomposite having a low melting viscosity, compared with in the conventional polyester/clay composite, it has an excellent processibility and dispersion characteristic of the clay particle.

The polyester/clay nanocomposite according to the present invention can replace conventional polyester resin presently used as electronic materials, as well as can be used as a compatibilizing agent for increasing compatibility of the conventional saturated polyester/clay composite.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A composition for preparing a polyester/clay nanocomposite, comprising a cyclic ester oligomer and a clay in a ratio of 100:0.1-10 by weight, in which the cyclic ester oligomer is intercalated between layers of the clay.

2. The composition according to claim 1, wherein the cyclic ester oligomer is one or more oligomers of a polyester selected from the group consisting of poly(ethylene terephthalate), poly(ethylene isophthalate), poly(butylene terephthalate), poly(2,6-dinaphtoate) and poly(ethylene 2,6-naphthalenedicarboxylate).

3. The composition according to claim 1, wherein the clay consists of an anionic phyllosilicate of layered aluminum silicate or magnesium silicate and Na⁺or K⁺ ion filled between the layers of the silicate.

4. The composition according to claim 3, wherein the phyllosilicate is selected from the group consisting of montmoillonite, hectorite, saponite, beidellite, nontronite, vermiculite and a halloysite.

5. A polyester/clay nanocomposite, comprising a polyester and a clay in a ratio of 100:0.1-10 by weight, in which the polyester is intercalated between layers of the clay and a distance between layers of the clay are separated 50 nm or more.

6. The polyester/clay nanocomposite according to claim 5, wherein the polyester is selected from the group consisting of poly(ethylene terephthalate), poly(ethylene isophthalate), poly(butylene terephthalate), poly(2,6-dinaphtoate) and poly(ethylene 2,6-naphthalenedicarboxylate).

7. The polyester/clay nanocomposite according to claim 5, wherein the clay consists of an anionic phyllosilicate of layered aluminum silicate or magnesium silicate and Na⁺ or K⁺ ion filled between the layers of the silicate.

8. The polyester/clay nanocomposite according to claim 7, wherein the phyllosilicate is selected from the group consisting of montmoillonite, hectorite, saponite, beidellite, nontronite, vermiculite, and a halloysite.

9. A method for preparing a polyester/clay nanocomposite comprising the steps of:
a) mixing a cyclic ester oligomer with an organically modified clay to obtain a mixture in which the cyclic ester oligomer is intercalated between silicate layers of the clay; and
b) polymerizing the cyclic ester oligomer intercalated between layers of the clay so as to separate interlayer distance of the clay to 50 nm or more.

10. The method according to claim 9, wherein the polymerization is carried out at 180-280° C.

11. The method according to claim 9, wherein the polymerization is carried out for 5-10 minutes.

12. The method according to claim 9, wherein a ratio between the polyester and clay in the polyester/clay nanocomposite is in the range of 100:0.1-10 by weight.

13. The method according to claim 9, wherein the cyclic ester oligomer is one or more oligomers of a polyester selected from the group consisting of poly(ethylene terephthalate), poly(ethylene isophthalate), poly(butylenes terephthalate), poly(2,6-dinaphtoate) and poly(ethylene 2, 6-naphthalenedicarboxylate).

14. The method according to claim 9, wherein the clay consists of an anionic phyllosilicate of layered aluminum silicate or magnesium silicate and Na⁺ or K⁺ ion filled between the layers of the silicate.

15. The method according to claim 14, wherein the phyllosilicate is selected from the group consisting of montmoillonite, hectorite, saponite, beidellite, nontronite, vermiculite, and a halloysite.

16. The method according to claim 9, wherein the polymerization in step (b) is carried out by a reaction molding process which is reaction injection molding or reactive extrusion.
